(19) United States
(12) Patent Application Publication
(10) Pub. No.: US 2025/0046882 A1
(43) Pub. Date: Feb. 6, 2025

(54) USE OF CARBON METAL COMPOSITE MATERIAL FOR SURFACE TREATMENT TO IMPROVE SODIUM WETTABILITY ON SOLID STATE ELECTROLYTES

(71) Applicant: Battelle Memorial Institute, Richland, WA (US)

(72) Inventors: Guosheng Li, Richland, WA (US); Minyuan Mil Li, Richland, WA (US); Evgueni Polikarpov, Richland, WA (US); David M. Reed, Richland, WA (US); Vincent L. Sprenkle, Richland, WA (US)

(73) Assignee: Battelle Memorial Institute, Richland, WA (US)

(21) Appl. No.: 18/718,172

(22) PCT Filed: Dec. 9, 2022
(86) PCT No.: PCT/US2022/052409

§ 371 Date: Jun. 10, 2024

Related U.S. Application Data
(60) Provisional application No. 63/288,868, filed on Dec. 13, 2021.

(51) Int. Cl. H01M 10/39; H01M 4/48; H01M 10/0562

(52) U.S. Cl. CPC H01M 10/399; H01M 4/48; H01M 10/0562; H01M 2300/0074

(57) ABSTRACT

An energy storage system that includes a molten sodium-containing salt in contact with a layer disposed on a surface of a β″-alumina solid electrolyte, wherein the surface layer comprises a composite comprising carbon, a metal, and a metal oxide.

### CROSS REFERENCE FROM RELATED APPLICATION

This application claims the benefit of U.S. Provisional Application 63/288,868, filed Dec. 13, 2021, which is incorporated herein by reference.

### ACKNOWLEDGMENT OF GOVERNMENT SUPPORT

This invention was made with Government support under Contract DE-AC0576RL01830 awarded by the U.S. Department of Energy. The Government has certain rights in the invention.

### BACKGROUND

The pressing demand for storing energy from renewable resources, such as intermittent solar and wind power, calls for the development of efficient, low cost and environmentally friendly electrochemical energy storage systems. A rechargeable sodium-based battery is, in principle, a viable alternative to the Li-ion battery (LIB), since sodium is earth-abundant, inexpensive, and offers simultaneously high volumetric and gravimetric energy densities.

Literature precedents on managing liquid metal anodes first took strides during development of the β″-alumina solid-state electrolytes (BASEs) for sodium-sulfur batteries in the 1960s, where this robust and active interface separates the molten sodium anode and the molten sulfur/polysulfide cathode. As the cell lifetime often correlates with the longevity of BASE and in particular the Na-BASE interface, a few decades of problem solving soon followed at both high and intermediate temperatures, accumulating insights to formulate more general strategies toward interfacial challenges at hand.

Early work on molten sodium-sulfur batteries between 30° and 350° C. showed that the edge interface on the BASE between the conducting (electrolyte area wetted by sodium) and the non-conducting area were susceptible to mechanical stress. The difference in pressure prompted pitting, electrolyte dissolution, or dendrite growth, which all contributed to the eventual cell failure. To reduce the edge state on the BASE, uniform and intimate wetting over the entire BASE area became a standing goal for interface engineering in sodium batteries to increase cell longevity. Likewise, for molten sodium batteries operating at intermediate temperatures (150 o 200° C.) and low temperatures (100 to 150° C.), good Na wettability is critical for successful battery operations including lower over potential, high capacity, long/stable cycle life, and so forth. In addition to heat treatment that removes adverse surface absorbents such as moisture, a variety of chemical modification has been applied to spread molten sodium evenly onto the BASE surface, including lead, tin, bismuth, platinum, iron oxide, and various carbon derivatives, such as sparked reduced graphene oxide.

### SUMMARY

Disclosed herein is an energy storage system comprising a molten sodium-containing salt in contact with a layer disposed on a surface of a β″-alumina solid electrolyte, wherein the surface layer comprises a composite comprising carbon, a metal, and a metal oxide.

Also disclosed herein is a method comprising applying an aqueous composition to a surface of a β″-alumina solid electrolyte, wherein the composition comprises (a) a carbon-containing material and (b) a metal-containing compound; and thermal treating the composition-applied β″-alumina solid electrolyte.

Further disclosed herein is a method for assembling an energy storage system, comprising applying an aqueous composition to a surface of a β″-alumina solid electrolyte comprising (a) a carbon-containing material and (b) a metal-containing compound; thermal treating the composition-applied β″-alumina solid electrolyte resulting in a surface-modified β″-alumina solid electrolyte; and contacting the surface-modified β″-alumina solid electrolyte with a molten sodium-containing salt.

Additionally disclosed herein is a method comprising operating a Na-metal halide battery at a temperature of less than, or equal to, 200° C., wherein the Na-metal halide battery comprises a molten sodium-containing anode salt in contact with a surface layer disposed on a β″-alumina solid electrolyte, wherein the surface layer comprises a composite comprising carbon, a metal, and a metal oxide.

The foregoing will become more apparent from the following detailed description, which proceeds with reference to the accompanying figures.

### BRIEF DESCRIPTION OF THE DRAWINGS

FIGS. 1A-1D. Carbon paste formation on the BASE. (FIG. 1A) Illustration of the carbon paste formulation, heat treatment, and sodium wetting application. Light blue coloring shows PbOₓ-coated (0≤x≤2) porosity in the carbon coating forming after heat treatment. (FIG. 1B) SEM and EDX mapping of Pb and C content. Surface morphology and composition analyses on BASE surfaces with carbon pastes of different lead loadings (CP1, CP2, and CP3) after heat treatment. The relative mass ratio of Pb and C follows 91.79:8.21 in CP1 (39.31:60.69 mol %), 4.05:55.95 in CP2 (4.36:95.64 mol %), and 15.43:84.57 in CP3 (1.05:98.95 mol %). The scale bars are 5 μm. (FIG. 1C) Powder XRD (PXRD) patterns on CP1, CP2, and CP3, identifying the presence of metallic Pb⁰ (referenced to ICSD 96501), β-PbO (referenced to ICSD 40180), and β-PbO₂ (referenced to ICSD 8492). (FIG. 1D) XPS spectra of CP1 and CP3.

FIGS. 2A-2D. Characterization of sodium metal wetting on a BASE disc with CP3. (FIG. 2A) Photos of the sodium metal wetting on a BASE disc treated with CP3, progressing from 110 to 150° C. Sodium wetting area is highlighted within the red dashed area, which increases with temperature. (FIG. 2B) SEM/EDS of the CP3 interface with BASE prior to sodiation. The scale bar is 5 μm. (FIG. 2C) SEM/EDS of the CP3 interface with BASE postsodiation. The scale bars are 5 μm unless notified otherwise. (FIG. 2D) PXRD patterns of CP1, prior (light gray) and post (black) sodiation, identifying the presence of Pb metal (referenced to ICSD 96501), while other reflections belonging to β-PbO (referenced to ICSD 40180) and β-PbO₂ (referenced to ICSD 8492) mostly disappeared postsodiation.

FIGS. 3A-3D. Morphology and composition characterization of the cross-section FIB lamella of CP1 (a) and CP3 (b-d). (FIG. 3A) SEM image of the CP1 FIB lamella and EDS mapping on Pb, C, and Pt. The relative mass ratio of Pb/C follows 1.37:98.63 (0.08:99.92 mol %). The scale bars are 500 nm. (FIGS. 3B, 3C) TEM images of the CP3 FIB lamella, including a high-resolution image of PbO₂ particle, identified through fast Fourier transform of the region. High-resolution image of (FIG. 3D) PbO particle (referenced to ICSD 40180) on the FIB lamella. The lattice spacing is 3.24 Å, which corresponded to the (111) plane of orthorhombic PbO. (FIG. 3E) High-resolution image of a metallic Pb⁰ particle identified in the oleic acid/toluene extraction (referenced to ICSD 8492).

FIGS. 4A-4D. Symmetric cell cycling with BASEs modified with CP3. (FIG. 4A) 3 mA h capacity cycling at various current densities and temperatures. (FIGS. 4B, 4C) EIS spectra of the CP3 symmetric cell at various temperatures. A simple cell model for fitting the EIS curve and fitted parameters. CPE1-P is a unitless parameter. Long-term stability study (FIG. 4D) on the CP3 symmetric cell at 120° C.

FIGS. 5A-5C. Scheme of Chemical Reactions with Sodium and Surface Wetting; (FIG. 5A) Interactions between liquid sodium with Pb⁰ microparticles forms a Na—Pb Interface and completes wetting on the particle surface, leading to good contact with the BASE surface; (FIG. 5B) sodium droplets form on an unfunctionalized carbon structure in the case of CP0, where liquid sodium is repelled and does not contact the BASE Surface; (FIG.>5C) PbO, nanoparticle-functionalized carbon structure; the complete conversion of PbOₓ nanoparticles to Pb°/Na—Pb particles (inset, right) allows liquid metal to achieve good contact along the surface; the oxide byproducts can repel liquid sodium, but the amount poses a small effect; overall, the PbOₓ nanoparticle-functionalized carbon structure interacts strongly with liquid sodium and guides it through the channels to the BASE surface.

FIGS. 6A-6B. Symmetric cell cycling with the BASE modified with SnOₓ-CP3. (FIG. 6A) 3 mA h capacity cycling at various current densities and temperatures. (FIG. 6B) Long-term stability study on the SnOₓ-CP3 symmetric cell at 120° C.

FIG. 7. Schematic view of carbon black-metal/metal oxide composite layer on a BASE.

### DETAILED DESCRIPTION

Alumina-phase solid electrolytes are good solid electrolytes for load-leveling batteries as they provide a strong ionic conductivity given the high concentration of sodium ions that pass through the electrolyte. Solid electrolytes comprised of β″-alumina phase material (known as β″-alumina phase solid electrolytes (BASE)) are preferred because sodium ions are the only conducting ions in the BASE material.

Among various Na-based rechargeable batteries, a ZEBRA battery is usually operated at relatively high temperatures (260˜320° C.), which is well above the melting point of the liquid electrolyte (NaAlCl₄, Tₘ at 157° C.), to achieve adequate battery performance by reducing the ohmic resistance of the β″-alumina solid-state electrolyte (BASE) and by improving the ionic conductivity of the secondary electrolyte.

However, particle growth and side reactions occurring in the cathode are also enhanced at high operating temperatures and can result in degradation of performance and/or lifetime. Therefore, an improved ZEBRA energy storage device that operates at lower temperatures is needed. Recently, intermediate-temperature (IT) Na-metal halide (Na-MH) batteries with operating temperature near 200° C. have demonstrated several advantages over conventional high-temperature ZEBRA batteries, including superior battery safety, lower operating temperatures, manufacturing cost, potentially longer cycle life, and easier assembly.

One of main challenges for developing practical lower temperature Na-MH batteries is the unique temperature dependence of the Na wettability on the BASE surface. Due to intrinsic features of molten sodium, the relatively high surface tension of molten sodium (˜200 mN/m) compared to water (˜73 mN/m) tends to work against good Na wetting and lead to poor Na wettability, which poses a huge technical barrier for the IT Na-MH batteries to be operated at even lower temperatures.

In the past, various methods have been employed to improve the Na wetting on the BASE surface. For tubular-type high temperature Na—S and ZEBRA batteries, a thin coating of carbon or carbon felt followed by a thermal treatment were applied on the BASE surface to improve the Na anode performance. Developing preferable sodium wetting at lower temperatures (<200° C.) is crucial for demonstrating lower operating temperature Na-MH batteries. One approach for improving Na wetting on BASE is sputtering a thin layer of metal coatings on vacuum heat-treated BASEs to remove possible impurities on the BASE surface such as moisture and surface hydroxyl groups. Metal coatings by sputtering (e.g., Sn, Bi, and In) or porous nanostructures (e.g., Ni nanowires, Pt mesh, and Pb particles) were applied to the surface of BASE to increase the adhesive energy between metal (Na)-metal coating contacts and to prevent moisture from being absorbed onto BASE. Another approach is using Na alloys (Na—Cs, Na—Bi), which improve the wettability by larger work of adhesion of Na alloys compared to that of pure Na.

However, most of methods reported in the literature either use surface treatment methods (sputtering, vacuum treatment, etc.) that are far less practical for large scale production or are associated with high-cost materials. Carbon materials were used in the past; however, its application was limited for the high temperature (>280° C.) batteries because a good Na wetting on carbon treated BASE is only available at higher temperatures.

Another previous method for improving Na wetting on BASE involves a surface treatment process through thermal decomposition of Pb(OAc)₂·3H₂O (LAT), which disseminated micron and submicron Pb particles on the ceramic surface (Chang et al., Decorating β″-alumina solid-state electrolytes with micron Pb spherical particles for improving Na wettability at lower temperatures, J. Mater. Chem. A 2018, 6, 19703-19711). During the evaluation of surface interactions, small contact angles from the sessile drop experiments trended qualitatively with good surface wetting, even though the increasing complexity of the surface modification resulted in a sunny-side-up drop behavior that required modeling beyond Young-Dupré relation. Furthermore, as we increased the treatment temperature of LAT, the surface metallic content of the Pb particles increased, which led to better wetting at temperatures as low as 120° C. As improved wetting was visually represented by a fast spread of molten metallic sodium, the key mechanism was attributed to the wicking or infiltration of metal into the treatment layer, promoted by formation of Na—Pb alloy on the particle surface in this case.

Disclosed herein is a method for drastically improving sodium (Na) wettability on the surface of solid-state. electrolytes, such as β″-alumina solid-state electrolyte (BASE), to augment the performance of Na batteries at lower temperatures. First, replacing the all-metal structure with a composite structure consisting of a metal-doped surface layer on a benign support, such as conventional carbon black, can significantly reduce the amount of toxic heavy elements overall. Second, using a high surface-to-volume nanoporous structure as the support, we can maximize both the surface interaction and the mass transport. Third, instead of a traditionally metallic modification, metal oxide nanoparticles can be converted in situ via sodium reduction (sodiation) to form active metal nanoparticles due to the reactive path length being on the order of particle size. Consequently, the formation of high-surface metallic particles creates wetting support with comparable total surface area but at a significantly lower reagent loading with a negligible quantity of byproducts. We disclose a carbon paste formulation that starts from low-cost carbon black to form a porous architecture with imbedded metal oxide nanoparticles after heat treatment, showing excellent wetting behavior at a fraction of the solid Pb loading. This approach can be further extended to Sn, thus eliminating a toxic element such as Pb.

The method disclosed herein involve applying an aqueous composition comprising (a) a carbon-containing material and (b) a metal-containing compound to a surface of a β″-alumina solid electrolyte; and thermal treating the composition-applied β″-alumina solid electrolyte.

Illustrative carbon-containing materials include carbon black, graphite, graphene, carbon fiber, and carbon felt. In certain embodiments, the carbon-containing material is carbon black. In certain embodiments, the carbon-containing material is the in form of a powder.

Illustrative metals for metal-containing compound include Pb. Sn, Sb, Ni, Zn, Bi, In, and Ga. The metal-containing compound can be in the form of a salt (including a hydrate of a salt). Illustrative salts include acetate, oxalate, formate, citrate and maleate.

The amount of carbon-containing material in the composition may range from 1 to 99 wt %, or 50 to 99 wt %, or 90 to 99 wt %, based on the total amount of the carbon-containing material and the metal-containing compound.

The amount of metal-containing compound in the composition may range from 0.001 to 15 wt %, or 0.001 to 5 wt %, or 0.001 to 1 wt %, based on the total amount of carbon-containing material and metal-containing compound.

The composition may also include an organic solvent for dispersing the carbon-containing material. Illustrative organic solvents include alcohols, ketones, organic amide and tetrahydrofuran.

The ingredients of the composition may be mixed together, and optionally ground, by any means. Illustrative mixing/grinding methods include milling (e.g., in a planetary mill).

The composition may be applied to the BASE surface under ambient atmospheric conditions. The composition may be applied to the BASE surface, for example, via brushing, drop casting, or spray coating.

After the composition is applied to the surface, the composition-applied surface is thermally treated. In certain embodiments, the composition-applied surface is subjected to a temperature of 100° C. to 550° C. In certain embodiments, the heat treatment is for 30 to 300 minutes.

In certain embodiments, the resulting surface-modified β″-alumina solid electrolyte comprises a surface layer, wherein the surface layer comprises a composite comprising carbon, a metal, and a metal oxide.

In certain embodiments, the metal and the metal in the metal oxide includes Pb, Sn, Sb, Ni, Zn, Bi, In, and Ga.

In certain embodiments, the amount of metal in the surface layer ranges from 0.001 to 30 wt %, or 0.001 to 15 wt %, or 0.001 to 7 wt %, based on the total weight of the surface layer.

In certain embodiments, the metal oxide is in the form of particles. In certain embodiments, the particles have a diameter of 10 to 500 nm.

In certain embodiments, the surface layer is porous.

In certain embodiments, the metal oxide is PbOₓ (0≤x≤2).

In certain embodiments, the metal oxide is SnOₓ (0≤x≤2).

In one embodiment, the method includes modifying the BASE surface by adding a thin composite layer comprising carbon black and metal oxide/metal submicron particles. The overall surface treatment process is simple and easy for scaling up. In certain embodiments, the BASE surface is simply brushed with a thick aqueous ink made of carbon black and metal compound precursors, and then followed by a heat treatment under an inert or a reducing environment.

The methods disclosed drastically reduce the operating temperature of molten sodium energy systems, thus can substantially accelerate their application in grid energy storage.

In certain embodiments, the unique surface treatment method disclosed herein drastically improves Na wettability near 125° C. IT Na-MH batteries adopting this new surface treatment can effectively demonstrate stable cell performances at lower operating temperatures, thus helping to reduce the cost of cell manufacturing and operation, and to improve the cell longevity for large scale energy storage applications.

In contrast to previously reported methods that have the theoretical root of improving Na wettability based on Young Dupré relation, the methods disclosed herein utilize the surface treatment method based sunny-side-up model, which describes, under certain conditions that as the total surface energy decreases as the liquid penetration progresses, a thin liquid film can expand along “Na-philic” surface cavities without overflowing the top of the texture on the rough surface.

In one embodiment, an ink consisting of carbon black, metal compound precursor(s), distilled water and a small amount of acetone were well mixed using a planetary mill. Then, using conventional brushing, a BASE surface is coated with a thin layer of the ink. After drying in the fume hood, the coated BASE is moved to a furnace and treated at a temperature up to 550° C. under nitrogen.

The surface-treated solid electrolyte disclosed herein is suitable as a component of sodium energy storage devices including, but not limited to, ZEBRA batteries, sodium metal halide batteries, liquid sodium batteries, molten sodium batteries, sodium-sulfur (Na/S) batteries, and intermediate temperature (<200° C.) sodium beta batteries. The surface-treated solid electrolyte disclosed herein is particularly useful in sodium metal halide batteries operated at temperatures of less than, or equal to, 200° C., or less than 150° C., or from 110 to 150° C. Sodium energy storage devices may be employed as components in energy producing devices and systems such as, e.g., power-grid systems and in other energy producing applications.

### Examples

Materials. Sodium iodide (ACS reagent, ≥99.5%), lead acetate trihydrate (Pb(OAc)₂·3H₂O, LAT, Sigma-Aldrich, >99%), tin oxalate (SnOₓ, Sigma-Aldrich, 98%), sodium (Alfa Aesar, 99.95% metal basis), tetraethylene glycol dimethyl ether (98%+), and acetone (Sigma-Aldrich, for HPLC, ≥99.9%) were used as received. Sulfur (Alfa Aesar, 99.999%) and Na2S4 (Alfa Aesar, 90+%) were heat treated at 90 and 200° C. under vacuum for 24 h, respectively. Carbon black (Fuel Cell Store, Vulcan XC-72R) was used as received. Deionized water (18 MΩ) was obtained from a Millipore system.

Carbon Paste Formulation. A mixture of 1.65 g of carbon black, 6 g of deionized water, 5 mL of acetone, and Pb(OAc)₂·3H₂O (LAT) (CP0 is the control sample with no lead content. CP1, 5 g LAT; CP2, 1 g LAT; or CP3, 0.2 g LAT) was added into a 100 mL stainless-steel milling jar. The mixture was ground on a planetary mill (Across Internationals, PQ-N) on a 30 min cycle (a 15 min milling with a 15 min pause in between) for a total time of about 6 h. After the jars were completely cooled, the carbon paste and grinding media were carefully transferred into HDPE bottles and kept on a roller mixer at 40 rpm to maintain the slurry consistency. SnOₓ-CP2 and SnOₓ-CP3 were made similarly by replacing LAT with SnOₓ. SnOₓ-CP1 was made by mixing 0.3 g of SnOₓ with 1.7 g of CP0. The amounts of the formulation ingredients are shown below in Table 1.

| | | | | | Total | | |
|---|---|---|---|---|---|---|---|
| | Carbon | DI | | | Slurry | | Theo. wt % |
| | Black | Water | Acetone | LAT | Mass | wt % | Pb Solid |
| | (g) | (g) | (g) | (g) | (g) | LAT | in Film |
| #1 | 1.65 | 30 | 3.92 | 5 | 40.57 | 12.32% | 62.3% |
| #2 | 1.65 | 30 | 3.92 | 1 | 36.57 | 2.73% | 24.9% |
| #3 | 1.65 | 30 | 3.92 | 0.2 | 35.77 | 0.56% | 6.2% |

The theoretical wt % Pb solid calculation assumes completely conversion from LAT to metallic Pb with no loss in carbon. The rest of the mass is assumed to be carbon. Pure LAT (MW 379.33) treatment consists of spreading a saturated aqueous solution (150 to 200 μL) over a 3 cm₂ ceramic disc substrate, which corresponds to approximately 77 mg of LAT and in the end 42 mg of Pb(assuming complete conversion, MW 207.2). With mass increase around 20 mg over a 3 cm₂ ceramic disc substrate after the heat treatment of carbon pastes, the solid Pb content was on the order of 1.2 mg for LAT-CP3 (5 mg for LAT-CP2 and 12 mg for LAT-CP1), significantly smaller than the previous pure LAT treatment (approximately 2.8%).

Heat Treatment and Wettability Study. The carbon paste, which may contain LAT, was brushed on one side of BASE discs (approximately 3 cm₂) to create a slurry coating. The samples were then heat-treated at 500° C. under a nitrogen gas atmosphere to convert the slurry coating into a solid film of PbO, (0≤x≤2) and carbon on the ceramic surface. After cooling, the treated BASEs were then transferred into a nitrogen-filled glovebox (oxygen and H₂O levels less than 0.1 ppm) with a surface layer approximately 15 to 20 mg.

During the wettability study, the samples were placed on a hot plate starting at 110° C., and a solidified droplet of metallic sodium was transferred to the BASE surface with glass Pasteur pipettes. The BASE disc with the sodium droplet atop is then covered with a stainless-steel sample cup to warm. The wetting behavior and contact angle were studied after the wetting was stabilized, up to 30 min for a particular temperature. After stabilizing the droplet at 110° C. for approximately 1 h, the temperature was increased by approximately 5° C. every 30 min. Aside from the time for inspection, the sodium droplet was covered to retain heat. Movies of sodium spread on LATCP3 and LAT-CP2 were captured and sped up to 4× to enhance clarity, similarly for SnOₓ-CP3.

Symmetric Cell Construction and Testing. A BASE disc was glass-sealed to an α-Al₂O₃ ring, as described previously. A helium leak test was performed to confirm no leakage from the glass-sealed assembly. Both sides of the BASE were coated with carbon paste (LAT-CP3 or SnOₓ-CP3) and heat-treated at 500° C. The treated samples were transferred into a glovebox for the subsequent cell assembly. The active area of the BASE is 3 cm₂. About 100 mg and 20 mg sodium were initially loaded to the anode and cathode sides of the symmetric cell, respectively.

The symmetric cell cycling experiments were carried out with a Landt CT3001A battery testing system, with the testing temperature varying between 11° and 150° C.

Sulfur Cell Construction and Testing. A BASE disc was glass sealed to an α-Al₂O₃ ring and leak-checked, as described previously. The surface of BASE facing the anode side was then coated with carbon paste (LAT-CP3) and heat-treated at 500° C. The treated samples were transferred into the glovebox for the subsequent cell assembly.

Cathode raw materials, sulfur (Alfa Aesar, 99.999%) and Na₂S₄ (Alfa Aesar, 90+%), were pretreated in a glovebox before use. The liquid catholyte was prepared by dissolving 1 mol NaI in tetraglyme at room temperature. After the 0.6 g of tetraglyme (4G) was heated to 120° C., a mixture (0.1 g) of S and Na₂S₄ with a mole ratio of 4:1 was added into the 4G solution, which was stirred for 2 h. In the meantime, the heat-treated BASE/α-Al₂O₃ ring was preheated to the same temperature. After the solution was transferred into the cathode chamber, a piece of carbon felt was inserted into the cathode chamber as a current collector. A foil and a spring made of Mo were placed on the top of the cathode carbon felt as current collectors. After 60 mg of sodium (slightly more than stoichiometric amount) was preloaded into an anode chamber of the cell, a spring-loaded stainless-steel shim, which served as a molten sodium reservoir, was inserted into the compartment. Anode and cathode end plates were then compression sealed to both sides of the α-Al₂O₃ ring using two polymer rings (fluorinated ethylene propylene for the cathode side and polyvinylidene fluoride for the anode side).

The assembled cell was heated to 120° C. for testing. The galvanostatic discharge/charge test was carried out with a BT-2000 Arbin battery testing system. The cells were initially discharged down to 1.1 V at 1 mA (˜0.33 mA/cm₂). The cells were then charged back to a cutoff voltage of 2.3 V under the same current. After the initial charge/discharge, the cells were cycled under various current densities with the voltage limits of 2.3 and 1.1 V.

Scanning Electron Microscopy. The morphological features of carbon paste modification (CP0, LAT-CP1, LAT-CP2, and LATCP3) on the BASE surfaces after heat treatment were analyzed with secondary electrons from a FEI Helios NanoLab 660 DualBeam scanning electron microscope. Fragments of the BASE discs with the treated surface layers were attached physically and electrically to the scanning electron microscopy (SEM) stubs with adhesive carbon tapes. Energy-dispersive X-ray spectroscopy (EDX) analysis was performed on the attached EDAX secondary electron detector systems to obtain the elemental composition of small areas of the sample. Elemental mapping was performed at 15-20 kV and 3.2 nA currents. Note that the mass % of lead in CP0 is less than 1%.

Before and after sodium wetting, the morphological features of carbon paste CP3 modification on the BASE surfaces were analyzed with a JEOL JSM 5910 scanning electron microscope. The cross-sectional features were examined with a JEOL 7001 scanning electron microscope, and the corresponding EDX mapping was performed with an Oxford Instruments system. The sample after sodium wetting was loaded into a transfer chamber under nitrogen before moving into a microscope antechamber to minimize air exposure.

Focused Ion Beam of Transmission Electron Microscopy Lamella and Transmission Electron Microscopy. The FEI Helios NanoLab 660 DualBeam system was used to fabricate transmission electron microscopy (TEM) sample of Pb/C electrodes. Surface imaging and morphology studies were done using secondary electrons.

To prepare the TEM specimen, a protecting Pt layer was deposited at the surface (to protect the surface from the gallium ion beam used during imaging) and a cross-sectional view was milled. The sample was lifted out onto a Cu-half grid. Final thinning and polishing of the TEM lamella were done at low current and voltage.

The TEM imaging was performed with a FEI Titan 80-300 microscope operated at 300 kV.

Electrochemical Impedance Spectroscopy. Electrochemical impedance spectroscopy (EIS) was performed on a potentiostat/galvanostat/zero-resistance ammeter unit (Reference 600+, Gamry Instruments) using a frequency range from 100 kHz to 0.1 Hz and an AC voltage amplitude of 10 mV.
Powder X-ray Diffraction. X-ray diffraction (XRD) patterns were obtained using a Rigaku MiniFlex II tabletop X-ray diffractometer (Cu Kα, 30 kV, 15 mA).
X-ray Photoelectron Spectroscopy. X-ray photoelectron spectroscopy (XPS) measurements were performed using a Physical Electronics Quantum 2000 Scanning ESCA Microprobe, which has a focused monochromatic Al Kα X-ray (1486.7 cV) source and a spherical section analyzer. The samples were prepared in a nitrogen purged glovebox and later were transferred into an Ar-purged glovebox attached to the XPS system. Then, the sample was loaded into an XPS detection chamber from the Ar-purged glovebox to avoid any exposure to air during the sample handling process.

As the attenuated total reflection-Fourier transform infrared (ATR-FTIR) measurements suggesting that the surface oxygen environment was mostly inorganic and PXRD measurements identifying a significant amount of PbO, the O 1s peak was calibrated at 529.7 eV for rhombic PbO, according to a peak separation of 391.7 eV with Pb 4f7/2. Because all samples contained a significant presence of carbon, the XPS spectra were not calibrated to adventitious carbon at 284.8 eV. The peak deconvolution was modeled with a Shirley background and a Pb 4f5/2-4f7/2 peak separation of 4.86 eV.

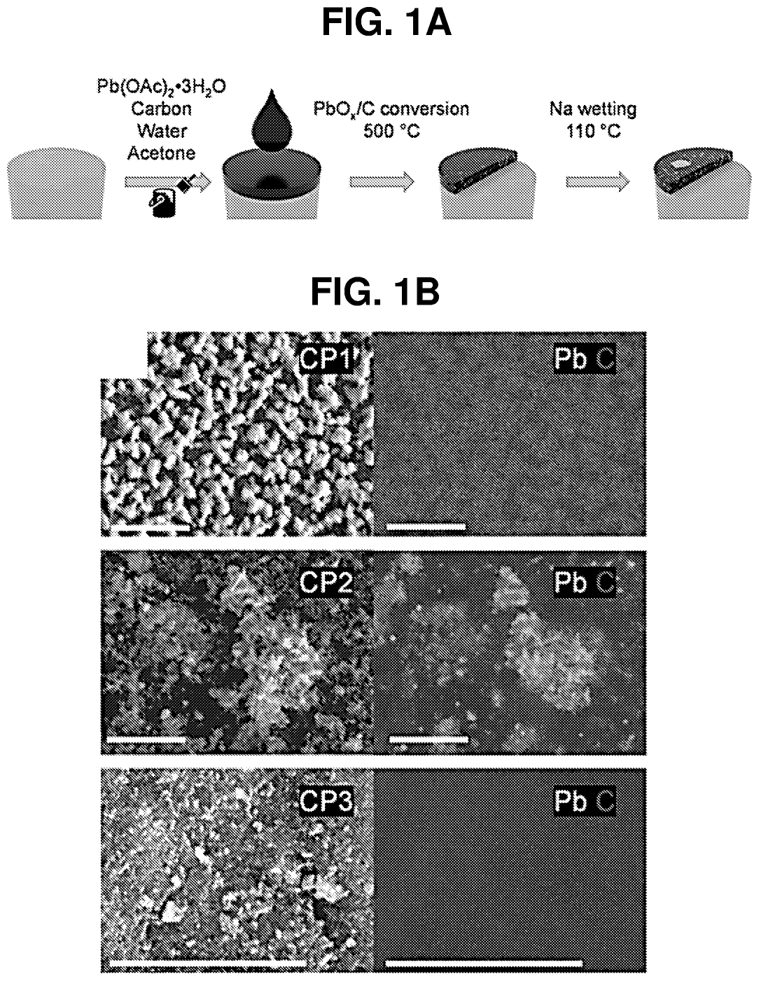

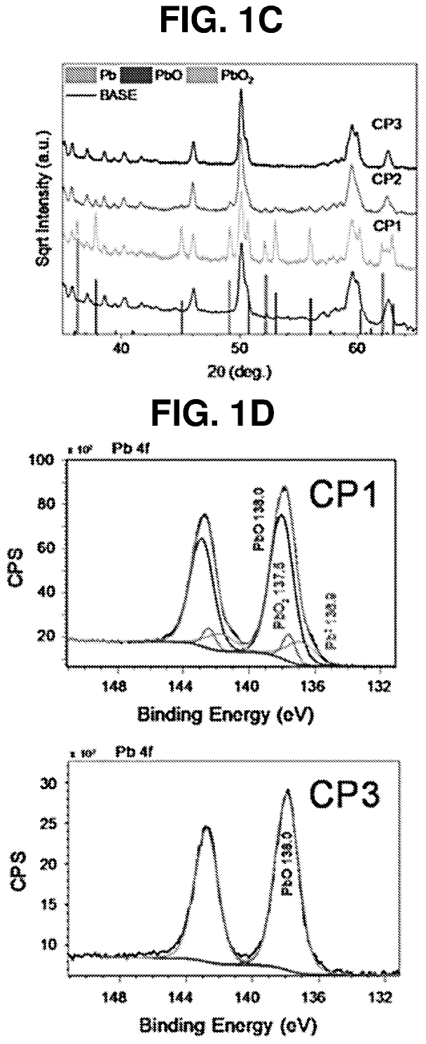

The carbon paste formula is exceedingly simple: only water, acetone, LAT, and carbon black powder were mixed and milled to an ink (FIG. 1A). After applying to the BASE surface and a heat treatment at 500° C., all paste formulations formed smooth black films on ceramic discs, labeled CP1 to CP3 by decreasing concentrations of LAT. Different Pb loadings in the paste (12 to 0.6 wt %, thus 62 to 6 wt % or 8.8 to 0.4 mol % theoretically in the solid. Loading in CP3 was calculated to be less than 3% of pure LAT treatment. The resulting surface morphologies were distinct from previously observed micron- and submicron-sized lead particles under the pure LAT treatment due to solid carbon dilution. By SEM and EDX, the microstructure and the associated elemental mapping provided representations of three distinct landscapes at different lead loadings (FIG. 1B).

In the surface layer with the highest Pb loading (CP1), fused particles between 0.2 and 0.5 μm in diameter formed a porous network on top (Pb/C, mass % 91.79:8.21, mol % 39.31:60.69, FIG. 1A). At lower concentrations, the network disappeared. In CP2, clusters on the order of 5-20 μm in diameter were embedded in the carbon matrix, with individual particles below the micron size (Pb/C, mass % 44.05:55.95, mol % 4.36:95.64, FIG. 1B). In CP3, where the lead loading is even lower, the surface layer was carbon-rich and lacked any identifying features of Pb or PbO, (Pb/C, mass % 15.43:84.57, mol % 1.05:98.95, FIG. 1. 0≤x≤2). Furthermore, the surface of CP3 closely resembled the carbon paste control with no lead addition (CP0, Pb/C<1% mass by EDX), showing small platelets on the order of 1 μm.

The PXRD pattern of CP1 (FIG. 1C, light grey) showed strong reflections of Pb metal (cubic, 20=36.27, 52.23, 62.12°), β-PbO (orthorhombic, 2Θ=37.82, 45.11, 53.08, 56.03, and) 63.01°, and β-PbO₂ (tetragonal, 2Θ=) 49.14°. The combination of PbO, PbO, and PbO₂ deviated from reported thermal behavior of LAT under nitrogen or under air, which might be due to the high carbon content. These reflections were considerably weaker in CP2 (FIG. 1C, gray) and became indistinguishable from the background signal in CP3 (FIG. 1C, black), as expected from dilution.

The vibrational spectra of CP1 and CP3 obtained via ATR-FTIR showed a lack of oxygen-containing functional groups (O—H, typically 3200 to 3400 cm⁻¹, and C═O, typically 1500 to 1800 cm⁻¹), suggesting the surface oxygen environment was highly inorganic. Combining with crystalline phase identification by PXRD, the separation of the Pb 4f_{7/2} peak and the O 1s peak in XPS (FIG. 1D. Note O 1s peaks were calibrated to 529.7 eV) was calculated to be 391.7 eV, which matched with orthorhombic β-PbO in all three cases (FIG. 1D). The subsequent deconvolution of the Pb 4f_{7/2} region also identified a significant amount of PbO (138.0 eV) with the minor presence of metallic Pb at 136.9 eV and PbO₂ at 137.5 eV in CP1 (FIG. 1D). The ratio of PbO₂/PbO/Pb⁰ was approximately 1:9.6:1.9, suggesting the crystalline network on the surface of CP1 consisted mainly of PbO. In addition, the deconvolution of Pb 4f region from both CP2 and CP3 also corresponded to a surface composition almost entirely of PbO (FIG. 1D).

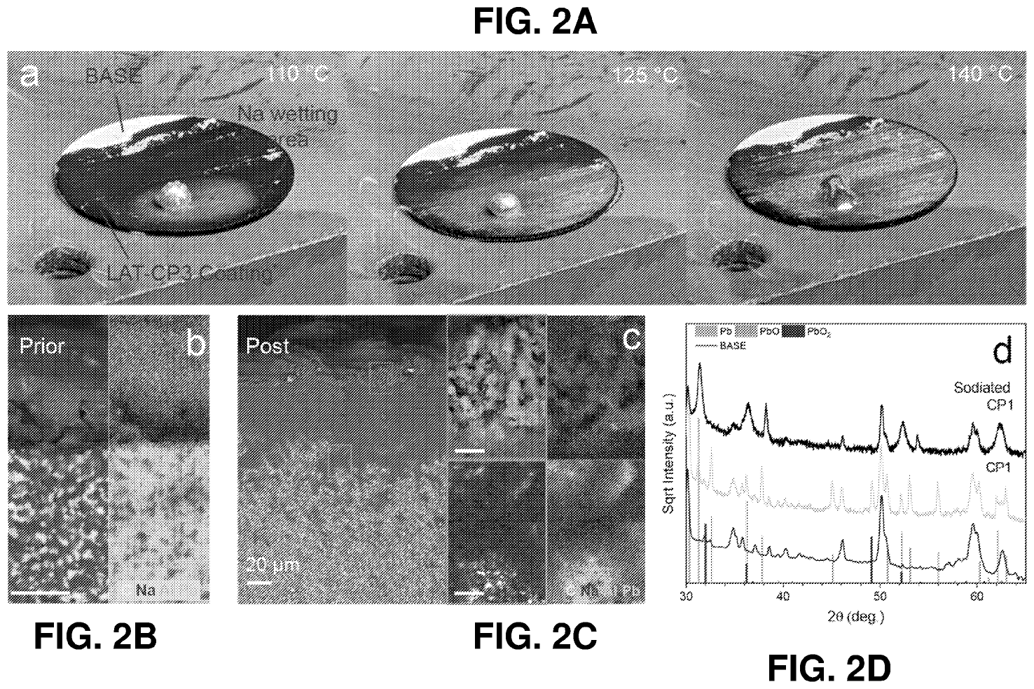

Literature examples of good sodium wetting on the pristine BASE without surface treatment typically required a temperature around 300° C. However, with LAT thermal treatment, we have shown good wetting around 120° C. with the spread of molten sodium. We expanded the experimental window further to 110° C., where molten metallic sodium began to spread on the surface layer, even on CP3 with a significantly lowered Pb content. As FIG. 2A has shown, the droplet on CP3 initially held its shape as liquid sodium leaked into the surface layer and spread underneath, slowly at first but covering the entire surface eventually. A faster spread at 110° C. was observed on CP2 (FIG. 2A). This droplet behavior on CP2 and CP3 closely resembled the sunny-side-up drop we previously found on the LAT surface at 175° C. Unlike the reflective surface characteristic of liquid sodium in CP2 or CP3, the spread of sodium on CP1 at 110° C. was more indicative by radiating color zones that propagated across the surface layer, likely corresponding to chemical reactions with sodium.

Overall, the large initial contact angles observed on CP2 and CP3 were also affected by solidification and potential contaminant (such as oxides) on the molten sodium droplet in addition to the intrinsic wetting properties of the carbon film, which implied that the contact angles of the sodium droplet were only qualitative indicators of surface interactions. As the temperature increased, the contact angle decreased more dramatically in CP2 and CP3, forming sunny-side-up drops (FIG. 2A). In contrast, sodium will readily form a sunny-side-up drop on CP1 even at 110° C. Unsurprisingly, CP0 showed no spread of metallic sodium even at 150° C. These visual cues indicated that the presence of PbO, additives, even in a small amount, was crucial toward sodium wetting.

Surface morphology changed significantly with the addition of molten sodium, as fiber-like structures with a diameter of approximately 1 μm was spurned from a featureless surface. The cross-section SEM of CP3 revealed a carbon-based surface layer a few microns in thickness (FIG. 2B). After addition of the liquid sodium, the sharp divide between the carbon film and the BASE surface was no longer easily visible. Instead, the sodium-rich region extended approximately 40 μm into the surface layer and the BASE (FIG. 2C). By PXRD, the sodiation on CP1 increased the intensities of the reflections belonging to Pb⁰, while the other reflections belonging to PbO or PbO₂ weakened or disappeared (FIG. 2D).

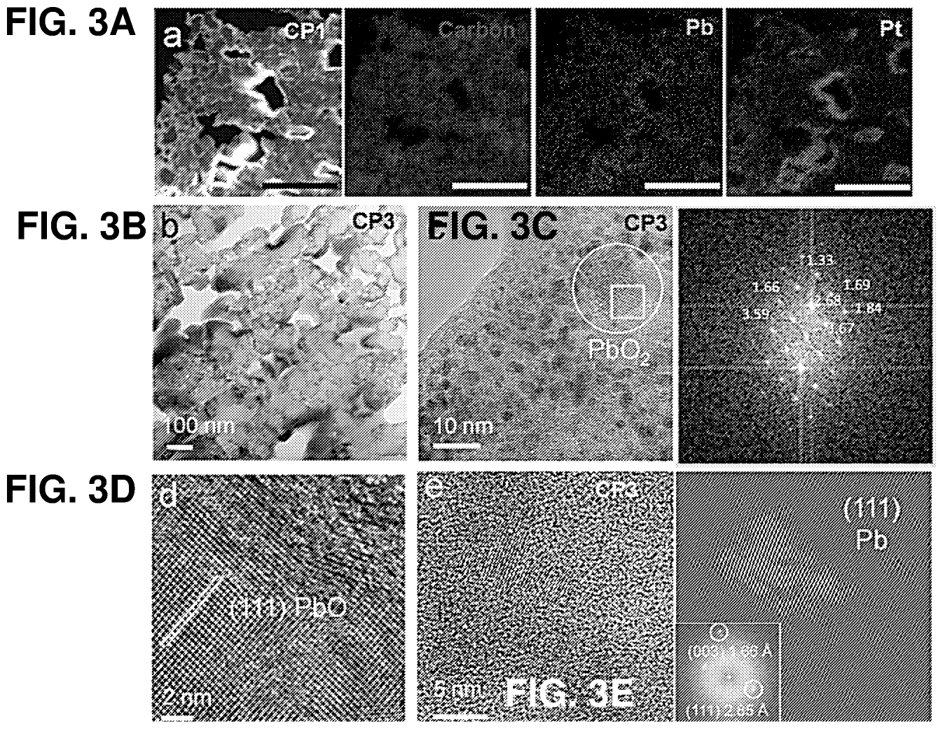

Upon closer inspection of a cross-section lamella obtained through focused ion beam (FIB) milling, EDX mapping revealed significant porosity in the carbon matrix, with an even distribution of Pb and carbon content throughout CP1 (Pb/C, mass % 1.37:98.63, mol % 0.08:99.92, FIG. 3A). The submicron voids in the surface layer, highlighted by sorption of Pt, could provide direct channels for molten sodium to infiltrate into the carbon matrix and reach the solid-state electrolyte underneath. In CP3, EDX was insufficient to fully resolve the distribution of Pb due to its low concentration. Instead, high-resolution TEM was used to identify the presence of PbOₓ (0≤x≤2). Similar to CP1, the cross section of the voids was highlighted by high-contrast regions, where small spherical Pt nanoparticles 2-5 nm in diameter were absorbed along the channel walls in the carbon matrix (FIGS. 3B, 3C. Among the densely populated Pt particles, a few larger PbO, nanoparticles of about 10-50 nm in diameter were more sparsely distributed (PbO₂ in FIG. 3C, PbO in FIG. 3D). Separately, the presence of PbO, particles could further be verified via oleic acid/toluene extraction of CP3 under sonication. From the extraction liquid, high-resolution TEM imaging showed a 10 nm metallic Pb⁰ particle, where the 2.85 Å reflection in the fast Fourier transform was assigned to the (111) plane (FIG. 3E). The inverse fast Fourier transform from the 2.85 Å reflection outlined the location of the particle and highlighted the crystal plane. Within the same extraction liquid, additional PbO, particles were identified, confirming that bulk composition of CP3 was similar to CP1. Overall, the TEM results from the FIB lamella on PbO, in the carbon matrix were in line with the XPS and PXRD results. With consideration of the reported phase transformation mechanisms on LAT, the carbon matrix likely diluted and separated the reaction intermediates such as Pb₂O₂(OAc)₂ and Pb₃O₂(OAc)₂, which were then unable to coalesce and undergo further thermal reduction to Pb.

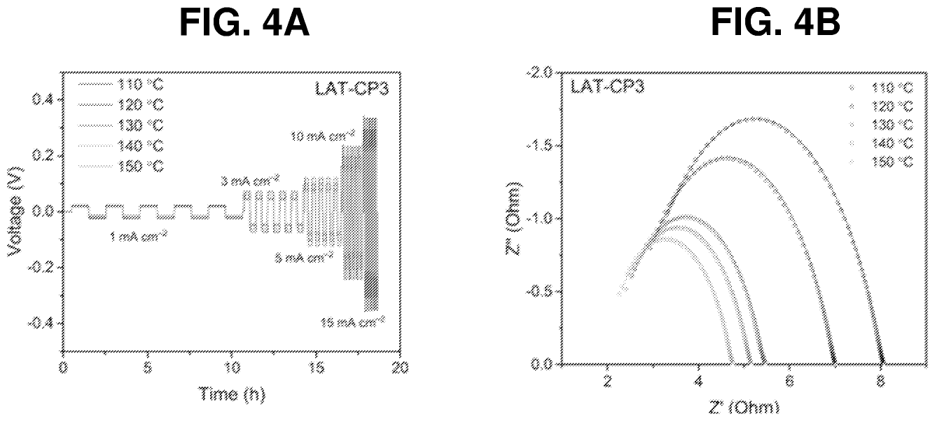

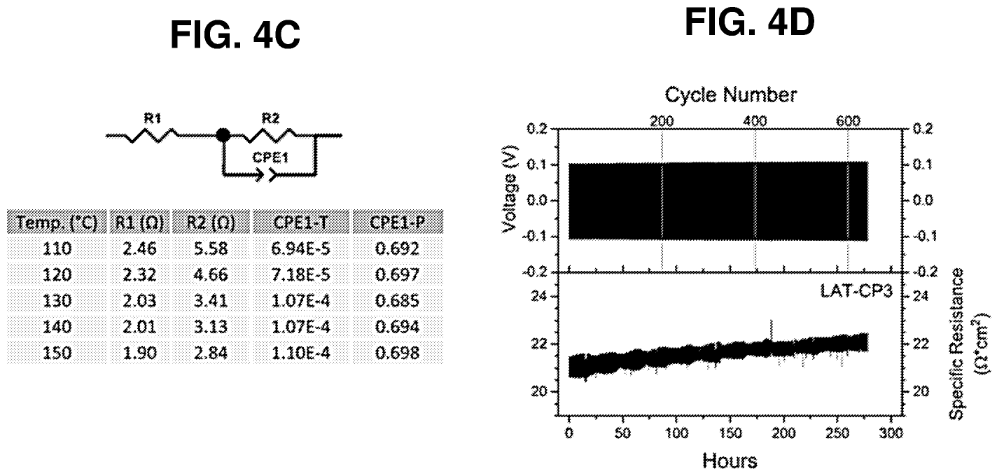

The Na transport properties of the CP3-coated BASE were examined by symmetric cell cycling between 11° and 150° C., passing a current density between 1 and 15 mA cm⁻² (FIG. 4A). Furthermore, the transport properties were examined by EIS (FIG. 4B) by a circuit model with two resistors and a constant phase element (FIG. 4C). The depressed semi-circle in the frequency region 15 k-20 kHz was likely characteristic of the charge-transfer process associated with the carbon paste interface (FIG. 4B). Long-term cycling showed stable voltage profiles and area specific resistance over 600 cycles, and in another instance close to 6000 cycles (FIG. 4D).

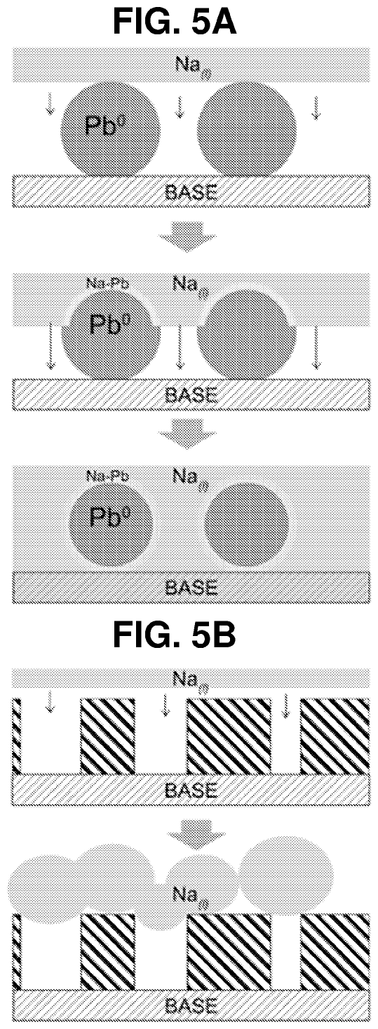

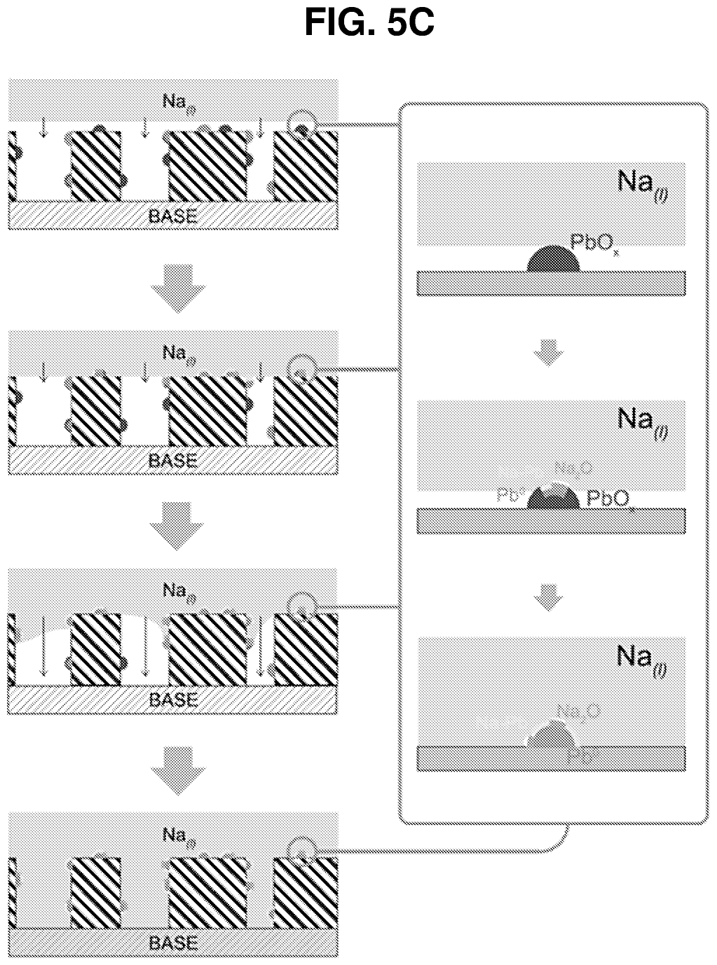

As a result of a stable and active interface, the Na—S cell with the CP3-modified BASE also could achieve an average stable cycling capacity as high as 509.0 mA h/g at 0.33 mA cm⁻² (˜C/50, theoretical specific capacity at 531.6 mA h/g), which was comparable with a previous cell with a pure LAT treatment of 520.2 mA h/g at the same rate. The consistency in performance indicated that the chemical function of the new Pb additives remained the same. Previously, we suspected the formation of a Na—Pb alloy, such as NaPb₃, on the particle surfaces would allow a more intimate contact between the liquid metal and the BASE. The mechanism here was likely the same, and the interactions between liquid sodium and Pb microparticles could be visualized in FIG. 5A.

The lack of an interactive surface, an unfunctionalized BASE, or a pure carbon coating in the case of CP0 (“sodiophobic”) prompted droplet formation, which would result in little contact toward liquid sodium (FIG. 5B). Surface oxidation, such as PbOₓ, on Pb microparticles would behave similarly, as we have shown previously by XPS that oxidation was still prominent 15 nm deep on particles upwards of 5 μm in diameter by depth profiling through Ar+ sputtering. However, sodiation could eventually break through the oxide shell and form metallic components at higher temperatures, as shown in equation 1:

$$PbO , {PbO}_{2} + Na \to {Pb}^{0} + Na - Pb + byproducts ( {Na}_{2} O )$$

In the new nanoporous carbon structures, the small sizes of the PbO and PbO₂ particles were on par with the thickness of the oxide shell, which implied that these particles could be reduced entirely with a very small amount of sodium metal to form a reactive metal surface (“sodiophilic surface”) and aid wetting (FIG. 5C). As an example of comparing a microparticle with a diameter of 1 μm and a collection of nanoparticles with a diameter of 50 nm, the total surface area of the 50 nm particles, even with a consideration of 2.8% mass, could provide more than 50% of surface area of 1 μm particles. The reactive coverage of the nanoparticles on the carbon structures helped to guide liquid sodium into the coating and connecting to the BASE surface (FIG. 2C and FIG. 5C).

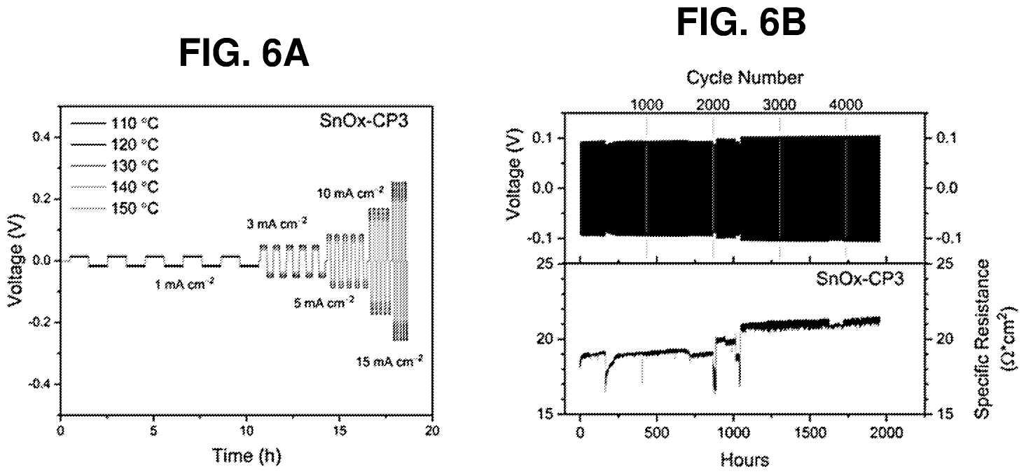

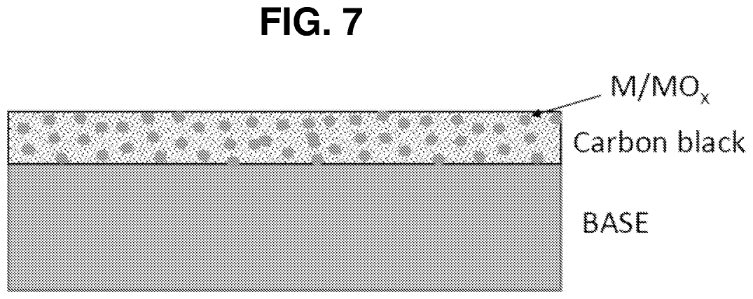

While most of the experimental data was gathered on PbO, particles, the previous analysis could easily extend to other metal/metal oxide nanoparticle systems as well. Especially for those compositions that follow thermal conversions, we could simply substitute LAT with another metal precursor. For example, tin (II) oxalate (SnOₓ) decomposes between 25° and 350° C. and form is SnO₂. Furthermore, metallic Sn⁰, the targeted sodiation product from SnO₂, is known to promote sodium wetting not only on solid-state electrolytes but also on electrolyte interphases of composite sodium electrodes. As expected, heat treatment of carbon paste containing tin oxalate on the BASE discs formed a smooth black film containing SnO₂. Sodium wetting was greatly enhanced at 120° C. at a theoretical solid SnO₂ content as low as 2% by mass. After sodiation, the reflections in PXRD corresponding to SnO₂ weakened significantly, very much like the observation on the PbOₓ system. The new surface modification showed comparable transport properties through symmetric cell cycling and EIS (FIGS. 6A-6B). The specific area resistance and voltage profiles remained stable after 4000 cycles (FIG. 5B). Replacement of Pb with Sn, from a persistent environmental toxin to a substance with no known harmful effects, is significant toward commercial applications of batteries based on beta-alumina.

By spreading the active metallic surface along the channel walls of a nanoporous carbon support, we enhanced the homogeneity in the chemical transport of sodium metal and the charge transport on the ceramic surface, stabilizing the BASE. The straightforward heat treatment of a carbon slurry containing LAT created a novel surface modification that improved molten sodium wetting with a spreading temperature as low as 110° C. Furthermore, we were able to significantly reduce the Pb content to about 3% of the previously published protocols with similar performance and even eliminate lead altogether by demonstrating similar cycling properties with a nontoxic Sn precursor. Featuring a composition prominent of air-stable oxide nanoparticles, the improvement on both function and cost could drastically reduce the challenge toward commercialization.

In view of the many possible embodiments to which the principles of the disclosed invention may be applied, it should be recognized that the illustrated embodiments are only preferred examples of the invention and should not be taken as limiting the scope of the invention.

1. An energy storage system comprising:
a molten sodium-containing salt in contact with a layer disposed on a surface of a β″-alumina solid electrolyte, wherein the surface layer comprises a composite comprising carbon, a metal, and a metal oxide.

2. The system of claim 1, wherein the metal oxide is in the form of particles.

3. The system of claim 1, wherein the surface layer is porous.

4. The system of claim 1, wherein the metal oxide is PbOₓ (0≤x≤2).

5. The system of claim 1, wherein the metal oxide is SnOₓ (0≤x≤2).

6. The system of claim 1, wherein the metal oxide is in the form of particles having a diameter of 10 nm to 500 nm.

7. A method comprising:
applying an aqueous composition to a surface of a β″-alumina solid electrolyte, wherein the composition comprises (a) a carbon-containing material and (b) a metal-containing compound; and
thermal treating the composition-applied β″-alumina solid electrolyte.

8. The method of claim 7, wherein the metal-containing compound is a metal-containing compound precursor that converts to a metal oxide upon the thermal treating.

9. The method of claim 8, wherein the carbon-containing material comprises carbon black, graphite, graphene, carbon fiber, carbon felt, or a combination thereof.

10. The method of claim 8, wherein carbon-containing powder is carbon black.

11. The method of claim 7, wherein the metal in the metal-containing compound is Pb, Sn, Sb, Ni, Zn, Bi, In, Ga, or a combination thereof.

12. The method of claim 7, wherein the metal in the metal-containing compound is Pb.

13. The method of claim 7, wherein the metal in the metal-containing compound is Sn.

14. The method of claim 7, wherein the metal-containing compound is in the form of a salt.

15. The method of claim 7, wherein the amount of carbon-containing material in the composition is from 50 to 99 wt %, based on the total amount of the carbon-containing material and the metal-containing compound.

16. The method of claim 7, wherein the amount of metal-containing compound in the composition is from 0.001 to 15 wt %, based on the total amount of carbon-containing material and metal-containing compound.

17. The method of claim 7, wherein the composition further comprises an organic solvent.

18. The method of claim 7, wherein the composition is brushed onto a surface of the β″-alumina solid electrolyte.

19. The method of claim 7, wherein the thermally treating comprises subjecting the composition-applied surface to a temperature of 100° C. to 550° C.

20. The method of claim 7, wherein the thermal treating comprises thermal treating at a temperature of 550° C.

21. The method of 20 claim 7, wherein the thermal treating is conducted under an inert or a reducing environment.

22. The method of claim 7, wherein the composition comprises (a) carbon black, (b) a Pb-containing compound, (c) water and (d) acetone.

23. A surface-modified β″-alumina solid electrolyte produced by the method of claim 7.

24. A method for assembling an energy storage system, comprising:
applying an aqueous composition to a surface of a β″-alumina solid electrolyte comprising (a) a carbon-containing material and (b) a metal-containing compound;
thermal treating the composition-applied β″-alumina solid electrolyte resulting in a surface-modified β″-alumina solid electrolyte; and
contacting the surface-modified β″-alumina solid electrolyte with a molten sodium-containing salt.

25. A method comprising operating a Na-metal halide battery at a temperature of less than, or equal to, 200° C., wherein the Na-metal halide battery comprises a molten sodium-containing anode salt in contact with a surface layer disposed on a β″-alumina solid electrolyte, wherein the surface layer comprises a composite comprising carbon, a metal, and a metal oxide.

26. The method of claim 25, wherein the operating temperature is less than 200° C.

27. The method of claim 25, wherein the operating temperature is less than 150° C.

28. The method of claim 25, wherein the operating temperature is 110° C. to 150° C.
